(19) United States
(12) Patent Application Publication
(10) Pub. No.: US 2007/0057762 A1
(43) Pub. Date: Mar. 15, 2007

(54) Remote control apparatus of wireless communication terminal and method for performing function thereof

(75) Inventors: Seung-Jea Han, Seongnam-si (KR); Ki-Tae Lee, Seoul (KR); Gi-Sok Oh, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/496,122

(22) Filed: Jul. 31, 2006

(30) Foreign Application Priority Data
Jul. 29, 2005 (KR) 2005-69880

(51) Int. Cl. H04L 9/32

(52) U.S. Cl. 340/5.26

(57) ABSTRACT

Disclosed is a remote control apparatus of a wireless communication terminal and a method for performing a function thereof. The apparatus includes an input unit for selecting remote control target equipment, and inputting a remote control command; a controller for setting a remote control mode for remotely controlling the remote control target equipment, informing the remote control target equipment to be remotely controlled, enabling the remote control target equipment to perform initialization, and detecting input through the input unit as input of the remote control command in the remote control mode; and a transceiver for generating a message for informing the remote control target equipment to be remotely controlled or a wireless signal corresponding to the remote control command and transmitting the generated message or wireless signal to the remote control target equipment, or receiving a wireless signal from the remote control target equipment.

### PRIORITY

This application claims priority under 35 U.S.C. § 119 to an application entitled “Remote Control Apparatus of Wireless Communication Terminal And Method For Performing Function Thereof” filed in the Korean Intellectual Property Office on Jul. 29, 2005 and assigned Serial No. 2005-69880, the contents of which are incorporated herein by reference.

### BACKGROUND OF THE INVENTION

1. Field of the Invention

The present invention relates generally to a wireless communication terminal, and in particular, to a remote control apparatus of a wireless communication terminal and a method for performing a function thereof.

2. Description of the Related Art

Digital broadcasting receivers such as a digital multimedia broadcasting (DMB) receiver, used in vehicular applications (e.g., in a car, truck, etc.) typically have a limited number of input keys. As such, user interface operations can be inconvenient. Even though a separate remote controller can be employed to compensate for this input key limitation, in vehicles, it is difficult to include many of the keys which are typically found in a home remote controller such as a settop box. Therefore, vehicle remote controllers are limited functionality.

Considering that a user can have several terminals (e.g., a wireless telephone, a digital broadcasting receiver, an MP3 player, and a remote controller for the digital broadcasting receiver), it is difficult to manage each device using a separate remote controller.

Accordingly, there is a need for a remote control apparatus for controlling dedicated digital broadcasting receivers.

### SUMMARY OF THE INVENTION

It is, therefore, an object of the present invention to provide a remote control apparatus of a wireless communication terminal, for enabling bidirectional communication with remote control target equipment, and a method for performing a function thereof.

It is another object of the present invention to provide a remote control apparatus and a method for performing a function thereof, in which a remote control function for a digital broadcasting receiver is added to a wireless telephone.

To achieve the above and other objects, there is provided a remote control apparatus in a wireless communication terminal, the apparatus including an input unit for selecting remote control target equipment, and inputting a remote control command; a controller for, upon detection of the selection, setting a remote control mode for remotely controlling the remote control target equipment, informing the remote control target equipment to be remotely controlled, enabling the remote control target equipment to perform initialization, and detecting input through the input unit as input of the remote control command in the remote control mode; and a transceiver for generating a message for informing the remote control target equipment to be remotely controlled or a wireless signal corresponding to the remote control command and transmitting the generated message or wireless signal to the remote control target equipment, or receiving a wireless signal from the remote control target equipment.

In another aspect of the present invention, there is provided a remote control apparatus in a wireless communication terminal, the apparatus including an input unit for selecting a digital broadcasting receiver as remote control target equipment, and inputting a remote control command; a controller for, upon detection of the selection, setting a remote control mode for remotely controlling the remote control target equipment, informing the remote control target equipment to be remotely controlled, enabling the remote control target equipment to perform initialization, and detecting input through the input unit as input of the remote control command in the remote control mode; a transmitter for generating a first wireless signal corresponding to the remote control command detected by the controller, and transmitting the generated first wireless signal to the remote control target equipment; and a transceiver for generating a message for informing the remote control target equipment to be remotely controlled or a second wireless signal corresponding to the remote control command and transmitting the generated message or second wireless signal to the remote control target equipment, or receiving a second wireless signal from the remote control target equipment.

In a further aspect of the present invention, there is provided a method for performing a remote control function of a wireless communication terminal, the method including checking whether any remote control target equipment is selected; upon detection of the selection, displaying a uni-direction/bi-direction communication mode menu; upon selection of the uni-direction communication mode menu, displaying a user interface for performing the remote control function; upon selection of the bi-direction communication mode menu, informing the selected remote control target equipment to be remotely controlled, and displaying a user interface for performing the remote control function; upon detection of channel selection through the user interface, informing the remote control target equipment of the channel selection; and when a channel is tuned, in a bi-direction communication mode, displaying information received from the remote control target equipment together with the user interface for performing the remote control function.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a wireless communication terminal and a digital broadcasting receiver according to the present invention;

FIG. 2A is a block diagram illustrating a remote control apparatus of a wireless communication terminal according to the present invention;

FIG. 2B is a block diagram illustrating a remote control apparatus of a wireless communication terminal according to the present invention;

FIG. 3A is a block diagram illustrating a remote control apparatus of a wireless communication terminal according to the present invention;

FIG. 3B is a block diagram illustrating a remote control apparatus of a wireless communication terminal according to the present invention.

FIGS. 4A to 4C are screen shots illustrating menu options for performing a remote control function of a wireless communication terminal according to the present invention;

FIG. 5 is a screen shot illustrating an infrared remote controller user interface screen displayed on a remote control apparatus of a wireless communication terminal according to the present invention;

FIG. 6 is a screen shot illustrating a Bluetooth remote controller user interface screen displayed on a remote control apparatus of a wireless communication terminal according to the present invention;

FIG. 7 is a flowchart illustrating a method for performing a remote control function of a remote control apparatus of a wireless communication terminal according to the present invention; and

FIG. 8 is a flowchart illustrating a method for performing a remote control function of a remote control apparatus of a wireless communication terminal according to the present invention.

### DETAILED DESCRIPTION OF THE PREFERRED EMBODIMENT

A preferred embodiment of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

Wireless communication terminals can include wireless telephones, mobile terminals, personal digital assistants (PDAs) and other like devices. These terminals can include not only their primary functions, but can include two or more functions together as well. For example, a wireless telephone can include a PDA and/or an MP3 function in addition to its own telephone function.

The wireless communication terminal, like the wireless telephone, can be conveniently carried by a user. Therefore, the wireless communication terminal is an ideal recipient for several additional functions which will be described below, and can greatly enhance user convenience.

Accordingly, in the present invention, the wireless communication terminal includes a remote control function for remotely controlling a digital broadcasting receiver.

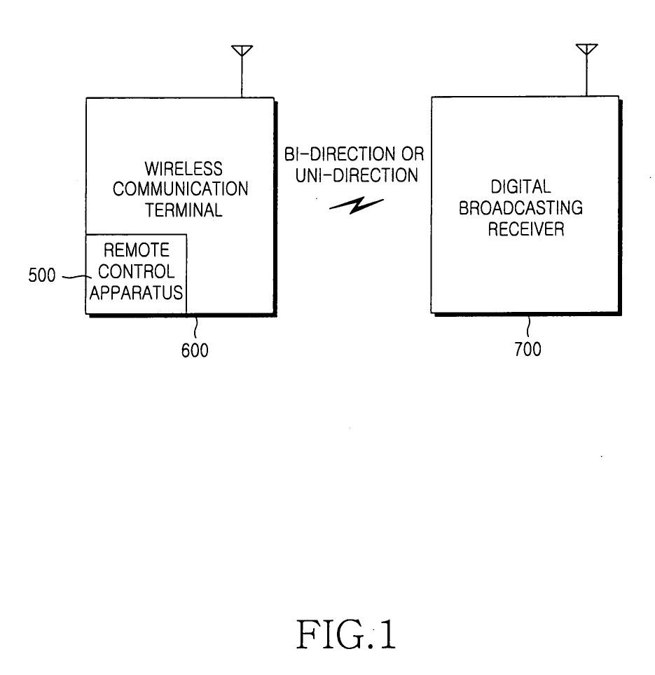

FIG. 1 is a block diagram illustrating the wireless communication terminal and the digital broadcasting receiver according to the present invention. The wireless communication terminal 600 includes a remote control apparatus 500, and performs the remote control function to control operation of the digital broadcasting receiver 700. Wireless communication between the wireless communication terminal 600 and the digital broadcasting receiver 700 is performed in bidirectional or uni-directional fashion. The bi-directional wireless communication can be accomplished using a Bluetooth or ZigBee compatible radio frequency (RF) transceiver, and the uni-direction wireless communication can be accomplished using an infrared light transmission scheme. However, it is also envisioned that other communication schemes can be used.

The digital broadcasting receiver 700 can detect channel up/down and other commands transmitted by the wireless communication terminal 600. Moreover, the digital broadcasting receiver 700 can, when a channel is tuned, transmit channel information or other information to the wireless communication terminal 600.

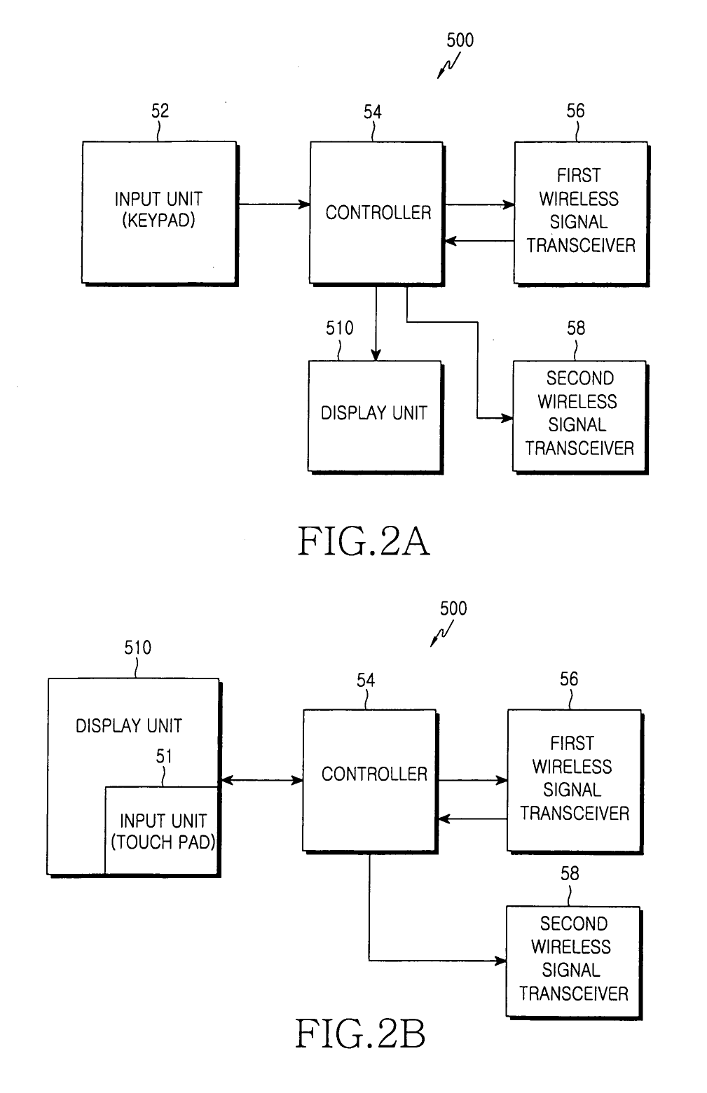

FIGS. 2A and 2B are block diagrams illustrating the remote control apparatus of the wireless communication terminal according to the present invention.

Referring to FIG. 2A, the remote control apparatus 500 includes an input unit 52, a controller 54, a first wireless signal transceiver 56, a second wireless signal transceiver 58, and a display unit 510. The input unit 52 is used to input a remote control command such as channel control of digital broadcasting to be reproduced through the digital broadcasting receiver 700, speaker volume control of the digital broadcasting receiver 700, and reproduction start or stop control of the digital broadcasting. The input unit 52 can include function keys, alpha numeric keys, soft keys, and/or any combination thereof.

The first wireless signal transceiver 56 generates and transmits a first wireless signal, which corresponds to input through the input unit 52, to the digital broadcasting receiver 700, or receives a first wireless signal from the digital broadcasting receiver 700. The first wireless signal can be embodied as a Bluetooth signal, for example. A second wireless signal transmitter 58 generates and transmits a second wireless signal, which corresponds to an input from the input unit 52, to the digital broadcasting receiver 700. The second wireless signal can be embodied as an infrared light signal, for example. A display unit 510 (e.g., a liquid crystal display, etc.) displays Electronic Program Guide (EPG) information received from the digital broadcasting receiver 700 through the first wireless signal transceiver 56. The EPG information is provided to the digital broadcasting receiver 700 from a digital broadcasting station (not shown). In case where the display unit 510 adopts a menu form, it displays a remote controller user interface menu, a model name menu, and a communication mode menu.

A controller 54 controls detection of a key input through the input unit 52, operation of the first wireless signal transceiver 56 or the second wireless signal transmitter 58, and display of the display unit 510. In other words, in case where the input unit 52 is embodied as a general keypad, the controller 54 detects a key in a remote control mode differently from a key input in a terminal (e.g., a call mode in a wireless phone). In other words, a numeric key can be detected as a digital broadcasting channel input key, or a volume or navigation key can be detected as a channel up/down key when in a remote control mode and can detect a same input key as a number key for entering a telephone number in a call mode.

FIG. 2B illustrates the remote control apparatus 500 of FIG. 2A with an input unit 51 is displayed to have an input screen form rather than using the display unit 510. In other words, an input unit 51 including a touch pad is substituted for the display unit 510 as shown in FIG. 2A. Accordingly, a user can touch any numeric key, for example, from keys displayed on a screen of the display unit 510, and in the remote control mode, a corresponding digital broadcasting channel number is inputted.

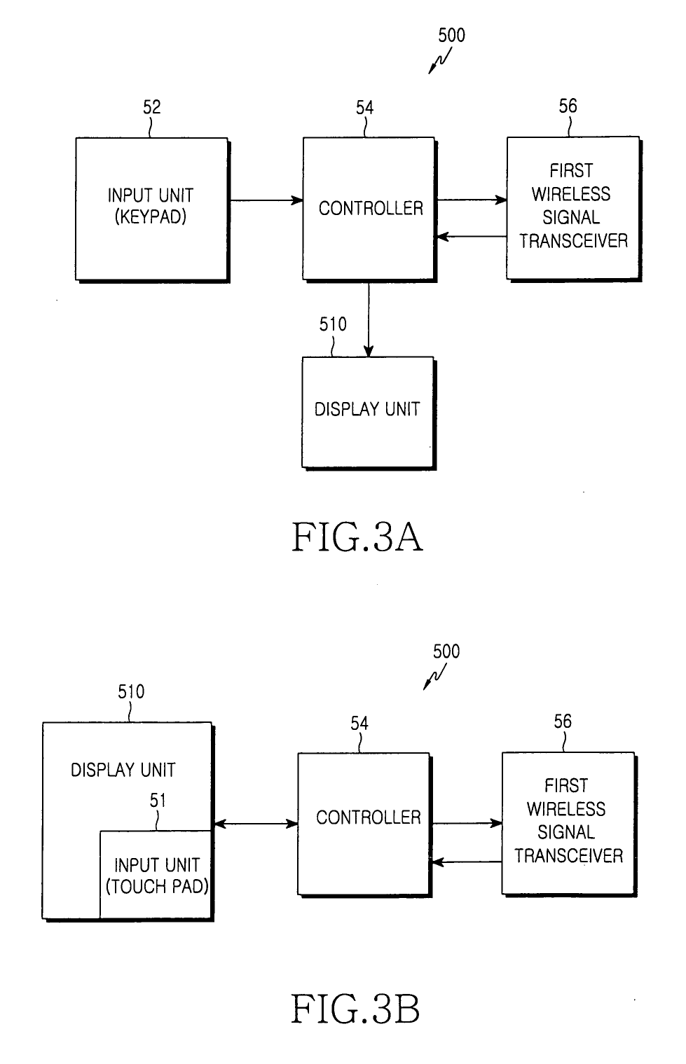

FIGS. 3A and 3B are block diagrams illustrating the remote control apparatus of the wireless communication terminal according to the present invention with a difference being that the second wireless signal transceiver 58 as shown in FIGS. 2A and 2B, is not provided.

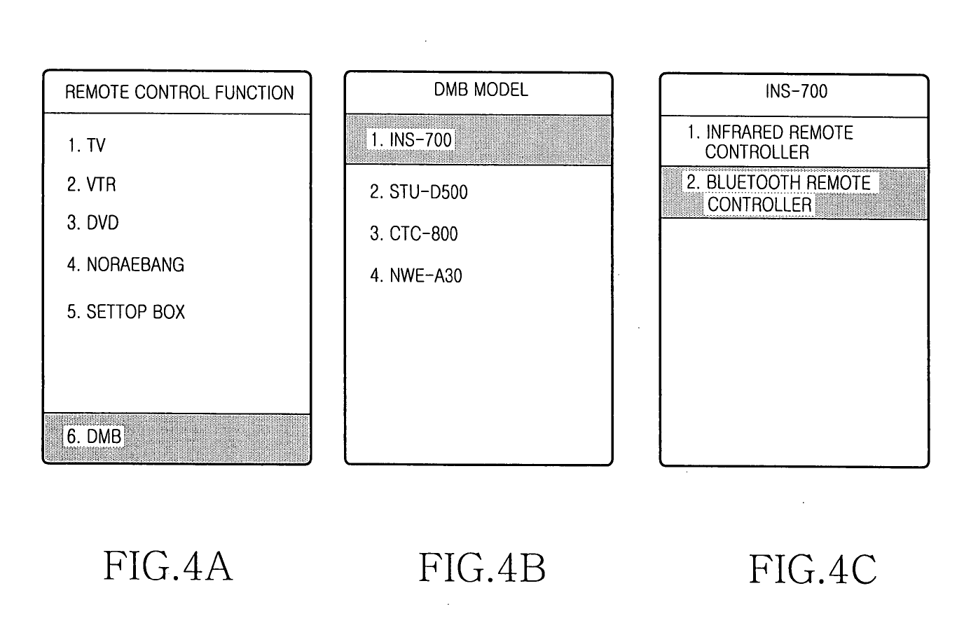

FIGS. 4A to 4C are screen shots illustrating menu options for performing the remote control function of the wireless communication terminal according to the present invention.

FIG. 4A is a screen illustrating the remote controller user interface menu, and showing an example including options such as “TV”, “VTR”, “DVD”, “Noraebang”, “settop box”, and “DMB which refer to various remote control target equipment”. When it is intended to remotely control a digital multimedia broadcasting (DMB) receiver using the remote control apparatus of the wireless communication terminal, the “DMB” option is selected from the options shown in FIG. 4A.

FIG. 4B shows a sub menu “DMB model” when the “DMB” option is selected. The “DMB model” is a DMB model name menu where options such as “INS-700”, “STU-D500”, “CTC-800”, and “NWE-A30” (which refer to various model or type designations of DMB equipment are arrayed.

FIG. 4C shows a sub menu “INS-700” when the “INS-700” option is selected from the DMB model names of FIG. 4B. The INS-700 menu has two options, that is, “infrared remote controller” and “Bluetooth remote controller”.

Assuming that the options where a cursor is currently placed are selected in a sequence of FIGS. 4A to 4C, the remote control apparatus of the wireless communication terminal is operated as the Bluetooth remote controller of the digital broadcasting receiver with its model name being the INS-700.

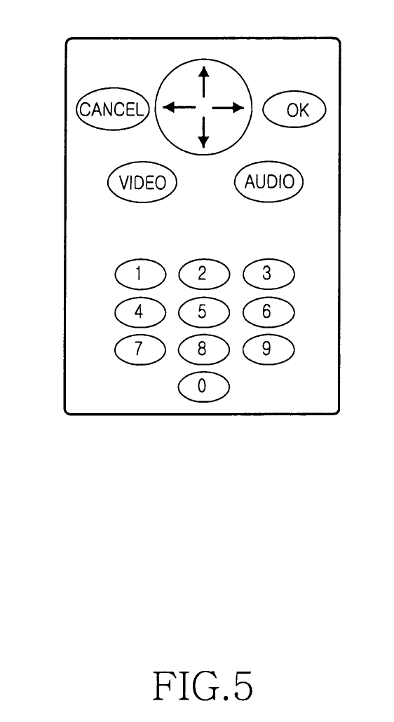

FIG. 5 is a screen shot illustrating an infrared remote controller user interface screen displayed on the remote control apparatus of the wireless communication terminal according to an exemplary embodiment of the present invention. Using this screen the user can select a navigation (up, down, left, and right) key, an OK key, a cancel key, a video key, an audio key, or the numeric key on the screen, thereby accomplishing the corresponding input by touching the screen 51. The numeric key is used to directly input the channel number, but it is of course assumed that channel change can be made through an up/down method using the navigation key. The keys shown are can be re-defined depending upon the remote control mode. For example, the keys re-defined for the wireless communication mode e.g., a numeric key definition is used for inputting a telephone number in the call mode when it is assumed that the wireless communication terminal is the wireless telephone while a channel number definition is used for inputting a channel selection, when in the remote control mode. However, some keys may not change their function (i.e., be re-defined upon the mode. For example, the cancel key is used to change a current mode (remote control mode) and return to an original mode (e.g. call mode). Therefore, the cancel key is not re-defined.

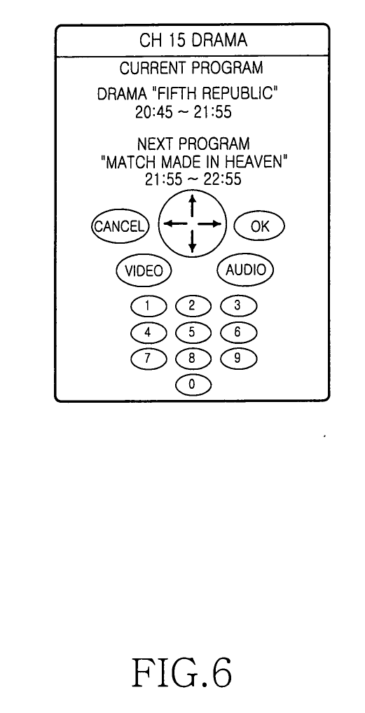

FIG. 6 is a screen shot illustrating a Bluetooth remote controller user-interface screen displayed on the remote control apparatus of the wireless communication terminal according to an exemplary embodiment of the present invention. If the wireless communication terminal and the digital broadcasting receiver support Bluetooth communication, the wireless communication terminal not only serves as a remote controller but also, when a digital broadcasting channel is selected, displays even channel information of the selected digital broadcasting channel. Similarly to the example shown in FIG. 5, a navigation key, an OK key, a cancel key, a video key, an audio key, or a numeric key are displayed on a partial screen region, and any key can be touchably selected by the user, to thereby the input the corresponding key. Further, the channel information can be displayed on another partial screen region. For example names and broadcasting times of current and next programs of a channel “15” can be displayed as shown in FIG. 6.

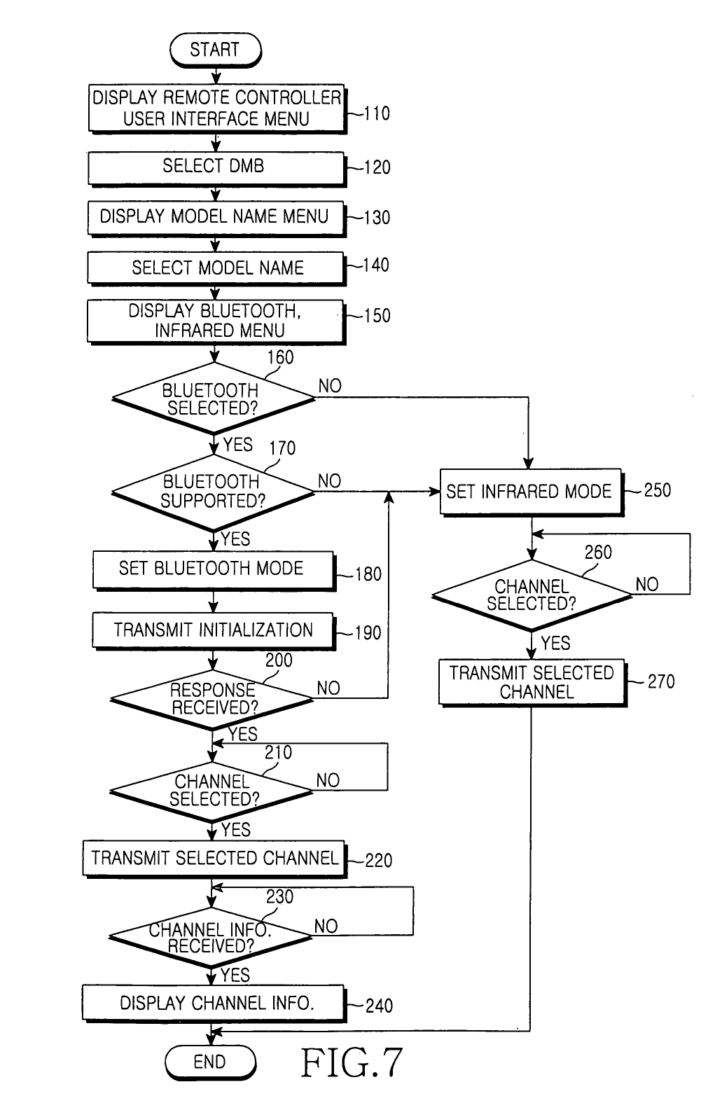

FIG. 7 is a flowchart illustrating a method for performing the remote control function of the remote control apparatus of the wireless communication terminal according to. In an example shown, it is assumed that a DMB receiver is remotely controlled using the remote control apparatus of the wireless communication terminal, and one of a Bluetooth mode and an infrared light mode can be selected.

In Step 110, the remote control apparatus displays the remote controller user interface menu. For example, the menu screen of FIG. 4A is displayed.

If the user views the displayed menu screen and selects the “DMB” option, in Step 120, the remote control apparatus detects the user's selection of the “DMB” option.

After the selection of the “DMB” option is detected, in Step 130, the remote control apparatus displays the model name menu. That is, the model name menu (in an array form) of the model names of the DMB receiver is displayed. This is better illustrated with reference to the exemplary screen shot of FIG. 4B.

If the user views the displayed screen and selects the model name, in Step 140, the remote control apparatus detects the user's selection of the model name.

After the selection of the model name is detected, in Step 150, the remote control apparatus displays the communication mode menu. In case where the remote control apparatus displays the Bluetooth mode or the infrared light mode (i.e., infrared remote controller mode), its example can be the screen of FIG. 4C.

After the displaying of the communication mode menu, in Step 160, the remote control apparatus checks whether the Bluetooth mode is selected.

If the user's selection of the Bluetooth mode is detected, in Step 170, the remote control apparatus checks whether the DMB terminal supports the Bluetooth mode.

If it is determined that the selection of the Bluetooth mode is not detected or the DMB terminal does not support the Bluetooth mode, in Step 250, the remote control apparatus is set to operate using the infrared light mode. Upon setting of the infrared light mode, similarly to conventional infrared remote controllers, the remote control apparatus can output the infrared light signal depending on user's input. This infrared light signal is used to remotely control the DMB terminal. Thus, in Step 260, the remote control apparatus checks whether the user selects a channel. Upon detection of the channel selection, in Step 270, the remote control apparatus transmits the selected channel to the DMB terminal, thereby enabling the DMB terminal to reproduce the selected channel.

On contrary, if it is determined that the DMB terminal supports the Bluetooth mode, in Step 180, the remote control apparatus is set to be in the Bluetooth mode.

After the setting of the Bluetooth mode, in Step 190, the remote control apparatus transmits an initialization signal to the DMB terminal. The DMB terminal receiving the initialization signal performs initialization so that it can be remotely controlled, and enters a standby state. In Step 200, the remote control apparatus checks whether it receives a response from the DMB terminal. If there is not the response, in Step 250, the remote control apparatus is converted and is set to operate in the infrared light mode as described above.

However, upon receipt of the response in the Step 200, in Step 210, the remote control apparatus checks whether the channel is selected by the user. Upon detection of the channel selection, in Step 220, the remote control apparatus transmits the selected channel to the DMB terminal, thereby enabling the DMB terminal to reproduce the selected channel.

After transmission of the selected channel, in Step 230, the remote control apparatus checks whether channel information has been received from the DMB terminal. If there is the received channel information, in Step 240, the remote control apparatus displays the channel information. Here, the channel information refers to the EPG information, and includes a some or all of a channel number, a program name, a song title, and a singer's name.

The channel selection of the Step 210 or 260 can be performed using any one of the keypad and the touch screen. If using the touch screen (such as shown in FIG. 5), a an additional step of displaying the user interface for performing the remote control function before the Step 210 or 260 may be used. Further, the user interface for performing the remote control can be displayed with the channel information (of the Step 240) as shown in FIG. 6.

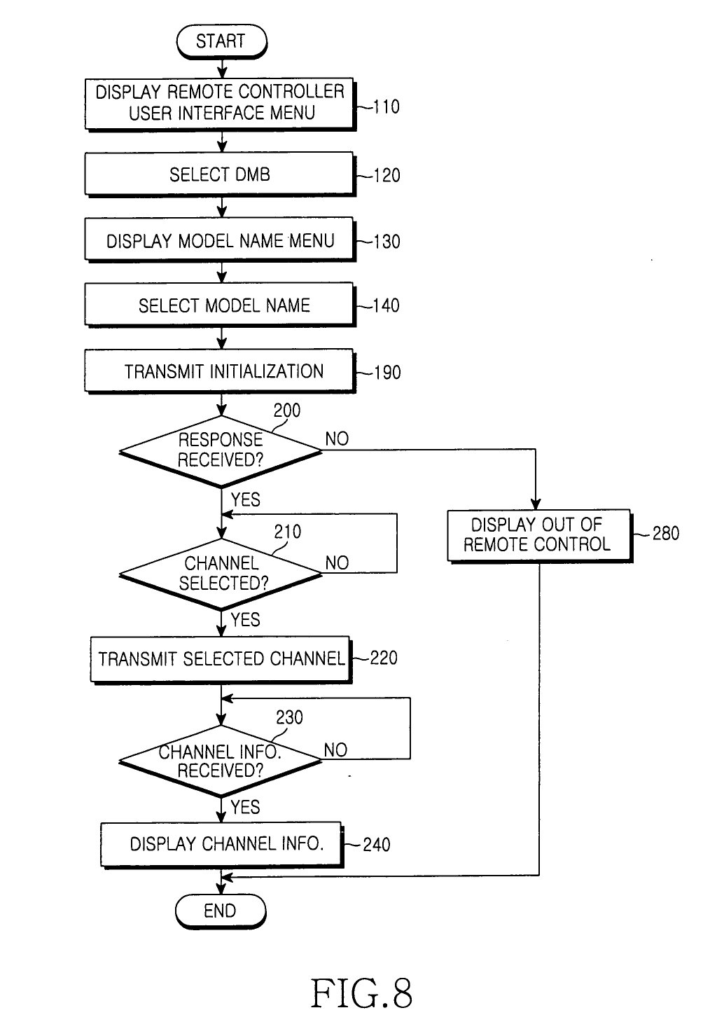

FIG. 8 is a flowchart illustrating another method for performing the remote control function of the remote control apparatus of the wireless communication terminal according to of the present invention.

In an example shown, it is assumed that the DMB receiver is remotely controlled using the remote control apparatus of the wireless communication terminal, and the Bluetooth communication can be made between the DMB receiver and the remote control apparatus of the wireless communication terminal.

In comparison with FIG. 7, the Steps 150 to 180 and the Steps 250 to 270 are not performed. With reference to FIG. 7, in case where the response is not received from the DMB receiver in the Step 200, the infrared light mode is set in Step 250, thereby making it possible to perform the remote control in another mode. However, in the example shown in FIG. 8, since only one communication mode (e.g., Bluetooth) is enabled for the remote control function, and “out of remote control” message is displayed in Step 280 when a response is not received in Step 200. Causes of the out of remote control condition, can include a unsupported terminal, distance between the wireless communication terminal and the digital broadcasting receiver which is beyond a specified standard, or communication obstacle, etc.

As described above, in the present invention, the wireless communication terminal is used as the remote controller to control a vehicle or dedicated digital broadcasting receiver, thus providing an effect of not requiring a separate remote controller, and increasing a user's convenience and satisfaction. Using a mobile terminal to remotely control devices rather than conventional separate remote controllers reduces the chances of loss and the inconvenience associated therewith. Further, the remote controller using the wireless telephone is advantageous as it can provide for the input of additional keys. And the remote controller using the wireless telephone is advantageous as it can directly input the channel number by numeric key of the wireless telephone instead of the up/down channel selection method. Additionally, in case where the DMB receiver is a Bluetooth communication support model, there is an advantage of viewing the DMB channel information through the screen of the wireless communication terminal.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A remote control apparatus in a wireless communication terminal, the apparatus comprising:
an input unit for selecting remote control target equipment, and inputting a remote control command;
a controller for, upon detection of the selection, setting a remote control mode for remotely controlling the remote control target equipment, informing the remote control target equipment to be remotely controlled, enabling the remote control target equipment to perform initialization, and detecting input through the input unit as an input of the remote control command in the remote control mode; and
a transceiver for generating a message for informing the remote control target equipment to be remotely controlled or a wireless signal corresponding to the remote control command and transmitting the generated message or wireless signal to the remote control target equipment, or receiving a wireless signal from the remote control target equipment.

2. The apparatus of claim 1, wherein the remote control target equipment is a digital broadcasting receiver.

3. The apparatus of claim 2, wherein the wireless signal is a Bluetooth signal.

4. The apparatus of claim 2, further comprising a display unit for displaying EPG (Electronic Program Guide) information received from the digital broadcasting receiver through the transceiver.

5. The apparatus of claim 2, wherein the input unit includes a keypad having a plurality of keys.

6. The apparatus of claim 2, wherein the input unit includes a display unit including a touch pad, the display unit for an input screen including a plurality of key.

7. The apparatus of claim 6, wherein the input unit displays a remote controller user-interface menu to enable selection of the digital broadcasting receiver as the remote control target equipment, and displays a model name menu of the digital broadcasting receiver to enable a model selection of the digital broadcasting receiver.

8. A remote control apparatus in a wireless communication terminal, the apparatus comprising:
an input unit for selecting a digital broadcasting receiver as remote control target equipment, and inputting a remote control command;
a controller for, upon detection of the selection, setting a remote control mode for remotely controlling the remote control target equipment, informing the remote control target equipment to be remotely controlled, enabling the remote control target equipment to perform initialization, and detecting input through the input unit as input of the remote control command in the remote control mode;
a transmitter for generating a first wireless signal corresponding to the remote control command detected by the controller, and transmitting the generated first wireless signal to the remote control target equipment; and
a transceiver for generating a message of informing the remote control target equipment to be remotely controlled or a second wireless signal corresponding to the remote control command and transmitting the generated message or second wireless signal to the remote control target equipment, or receiving a second wireless signal from the remote control target equipment.

9. The apparatus of claim 8, wherein the remote control target equipment is the digital broadcasting receiver.

10. The apparatus of claim 9, wherein the input unit displays a uni-direction/bi-direction communication mode menu and enables selection of a communication mode.

11. The apparatus of claim 9, wherein, after the second wireless signal for informing to be remotely controlled is transmitted to the digital broadcasting receiver, the controller automatically converts to a uni-direction communication mode and performs remote control, if a response from the digital broadcasting receiver is not received.

12. The apparatus of claim 8, wherein the wireless communication terminal is a wireless telephone.

13. The apparatus of claim 9, wherein the wireless communication terminal is a wireless telephone.

14. A method for performing a remote control function of a wireless communication terminal, the method comprising:
checking whether any remote control target equipment is selected;
upon detection of the selection, displaying a uni-direction/bi-direction communication mode menu;
upon selection of the uni-direction communication mode menu, displaying a user interface for performing the remote control function;
upon selection of the bi-direction communication mode menu, informing the selected remote control target equipment to be remotely controlled, and displaying a user-interface for performing the remote control function;
upon detection of channel selection through the user interface, informing the remote control target equipment of the channel selection; and
when a channel is tuned, in a bi-direction communication mode, displaying information received from the remote control target equipment together with the user-interface for performing the remote control function.

15. The method of claim 14, wherein the step of checking whether any remote control target equipment is selected includes:
displaying a remote controller user interface menu showing remote control target equipments and
upon user's selection of specific remote control target equipment from the displayed menu, detecting the user's selection.

16. The method of claim 15, wherein the remote control target equipment includes the digital broadcasting receiver.

17. The method of claim 15, wherein the uni-direction communication mode includes an infrared light communication mode, and the bi-direction communication mode includes a Bluetooth communication mode.

18. The method of claim 15, wherein the wireless communication terminal includes a wireless telephone.

19. The method of claim 16, wherein digital broadcasting channel information is displayed together with the user interface for performing the remote control function.

20. The method of claim 14, wherein, if a response to the informing is not received from the selected remote control target equipment, conversion to a uni-direction communication mode is performed, and the user-interface for performing the remote control function is displayed.
